(19) United States
(12) Patent Application Publication
(10) Pub. No.: US 2006/0102115 A1
(43) Pub. Date: May 18, 2006

(54) Compression ratio variable device of internal combustion engine

(75) Inventor: Makoto Hirano, Wako-shi (JP)

Correspondence Address: BIRCH STEWART KOLASCH & BIRCH, PO BOX 747, FALLS CHURCH, VA, 22040-0747, US

(73) Assignee: Honda Giken Kogyo Kabushiki Kaisha, Tokyo (JP)

(21) Appl. No.: 10/523,692

(22) PCT Filed: Aug. 4, 2003
(86) PCT No.: PCT/JP03/09856

§ 371 Date: Oct. 14, 2005

(30) Foreign Application Priority Data
Aug. 5, 2002 (JP) 2002-227790

(51) Int. Cl. F02B 75/04

(52) U.S. Cl. 123/78 B; 123/48 B

(57) ABSTRACT

An internal combustion engine variable compression ratio system is provided that includes a piston inner (5a), a piston outer (5b) that, while being fitted around the outer periphery of the piston inner (5a), so that it can slide only in the axial direction, is capable of moving to a low compression ratio position (L), a high compression ratio position (H), and a medium compression ratio position (M) between the above positions, and two sets of raising means (R₁, R₂) disposed in line in the axial direction between the piston inner and outer (5a, 5b), each set of raising means (R₁, R₂) including a movable raising member (14₁, 14₂), which can pivot individually between a non-raised position (A) and a raised position (B) around the axis of the piston inner and outer (5a, 5b). It is thus possible to provide an internal combustion engine variable compression ratio system that enables the compression ratio to be appropriately switched between at least three stages, that is, a low compression ratio, a medium compression ratio, and a high compression ratio, without rotating the piston outer.

### FIELD OF THE INVENTION

The present invention relates to an internal combustion engine variable compression ratio system and, in particular, to an improvement thereof in which a piston includes a piston inner and a piston outer, the piston inner being connected to a connecting rod via a piston pin, and the piston outer, while being connected to the piston inner and having an outer end face thereof facing a combustion chamber, being capable of moving between a low compression ratio position close to the piston inner and a high compression ratio position close to the combustion chamber, the compression ratio of the engine being decreased by moving the piston outer to the low compression ratio position, and the compression ratio being increased by moving the piston outer to the high compression ratio position.

### BACKGROUND ART

Conventionally, with regard to such an internal combustion engine variable compression ratio system, there is a known system (1) in which a piston outer is screwed around the outer periphery of a piston inner, and rotating the piston outer forward and backward so that it approaches and recedes from the piston inner moves it to a low compression ratio position and a high compression ratio position (for example, Japanese Patent Application Laid-open No. 11-117779), and a known system (2) in which a piston outer is fitted in an axially slidable manner around the outer periphery of a piston inner, an upper hydraulic chamber and a lower hydraulic chamber are formed between the piston inner and the piston outer, and supplying hydraulic pressure alternately to these hydraulic chambers moves the piston outer to a low compression ratio position and a high compression ratio position (for example, Japanese Patent Publication No. 7-113330).

Depending on the running conditions of the internal combustion engine, it may be necessary for the compression ratio to be switched between three or more stages, but it is difficult to satisfy such a requirement with the above-mentioned conventional system (1) or (2). Furthermore, in the conventional system (1), since it is necessary to rotate the piston outer in order to switch the compression ratio, the shape of the top face of the piston outer is restricted by the shape of the ceiling of the combustion chamber or the arrangement of intake and exhaust valves, and it cannot be set freely.

### DISCLOSURE OF INVENTION

It is therefore an object of the present invention to provide an internal combustion engine variable compression ratio system that enables the compression ratio to be appropriately switched between three stages, that is, a low compression ratio, a medium compression ratio, and a high compression ratio, without rotating the piston outer.

In order to attain the above-mentioned object, in accordance with an aspect of the present invention, there is provided an internal combustion engine variable compression ratio system that includes a piston inner connected to a connecting rod via a piston pin, a piston outer that, while being fitted around the outer periphery of the piston inner so that the piston outer can slide only in the axial direction and having an outer end face facing a combustion chamber, is capable of moving to a low compression ratio position close to the piston inner, a high compression ratio position close to the combustion chamber, and at least one medium compression ratio position between the low compression ratio position and the high compression ratio position, and at least two sets of raising means disposed in line in the axial direction between the piston inner and the piston outer, each set of raising means including a movable raising member, the movable raising members being individually capable of pivoting between a non-raised position and a raised position around the axis of the piston inner and outer, the piston outer being held at the low compression ratio position when two of the movable raising members are pivoted to the non-raised position, the piston outer being held at the medium compression ratio position when only one of the movable raising members is pivoted to the raised position, and the piston outer being held at the high compression ratio position when two of the movable raising members are pivoted to the raised position.

In accordance with this aspect, it is possible to appropriately switch the position of the piston outer between at least three stages, that is, the low compression ratio position, the medium compression ratio position, and the high compression ratio position, only by pivoting at least two movable raising members between just two positions, that is, the non-raised position and the raised position, thereby enabling a close correspondence with various running conditions of the internal combustion engine.

Moreover, since the piston outer does not rotate relative to the piston inner even when the position of the piston outer is being controlled, by making the shape of the top face of the piston outer, which faces the combustion chamber, match the shape of the combustion chamber or the arrangement of intake and exhaust valves, the compression ratio when the piston outer is at the high compression ratio position can be increased effectively.

### BRIEF DESCRIPTION OF DRAWINGS

FIG. 1 to FIG. 21 show a first embodiment of the present invention; FIG. 1 is a vertical sectional front view of an essential part of an internal combustion engine equipped with a variable compression ratio system of the first embodiment of the present invention, FIG. 2 is an enlarged sectional view along line 2-2 in FIG. 1, showing a low compression ratio state, FIG. 3 is a sectional view along line 3-3 in FIG. 2, FIG. 4 is a sectional view along line 4-4 in FIG. 2, FIG. 5 is a sectional view along line 5-5 in FIG. 2, FIG. 6 is a sectional view along line 6-6 in FIG. 2, FIG. 7 is a sectional view along line 7-7 in FIG. 2, FIG. 8 is a sectional view along line 8-8 in FIG. 2, FIG. 9 is a view, corresponding to FIG. 2, showing a medium compression ratio state, FIG. 10 is a sectional view along line 10-10 in FIG. 9, FIG. 11 is a sectional view along line 11-11 in FIG. 9, FIG. 12 is a sectional view along line 12-12 in FIG. 9, FIG. 13 is a view, corresponding to FIG. 2 and FIG. 9, showing a high compression ratio state, FIG. 14 is a sectional view along line 14-14 in FIG. 13, FIG. 15 is a sectional view along line 15-15 in FIG. 13, FIG. 16 is a sectional view along line 16-16 in FIG. 13, FIG. 17 is a diagram for explaining the operation of each section in the low compression ratio state, FIG. 18 is a diagram for explaining the operation of each section in the medium compression ratio state, FIG. 19 is a diagram for explaining the operation of each section in the high compression ratio state, FIG. 20A to FIG. 20E are diagrams for explaining the operation of the first and second raising means, and FIG. 21 is a sectional view along line 21-21 in FIG. 15.

FIG. 22A to FIG. 22E are diagrams corresponding to FIG. 20A to FIG. 20E, showing a second embodiment of the present invention.

### BEST MODE FOR CARRYING OUT THE INVENTION

Modes for carrying out the present invention are explained below with reference to embodiments of the present invention shown in the attached drawings.

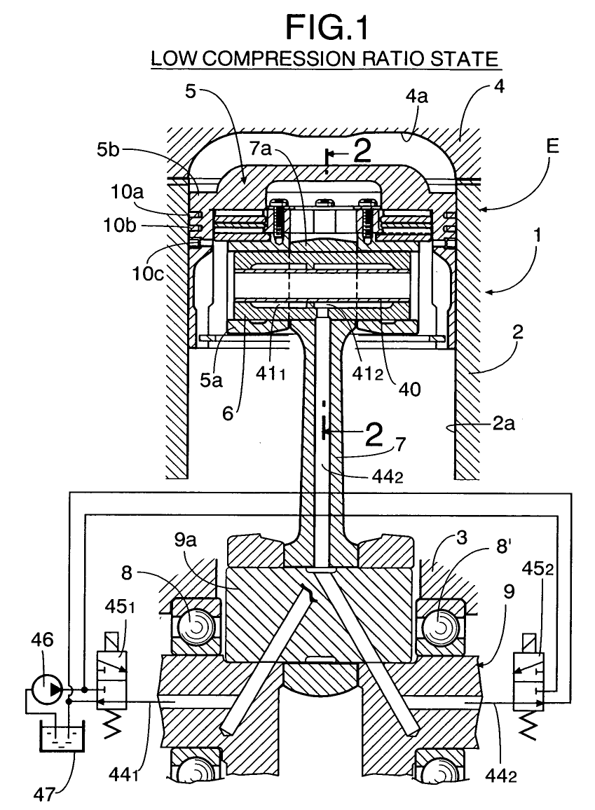

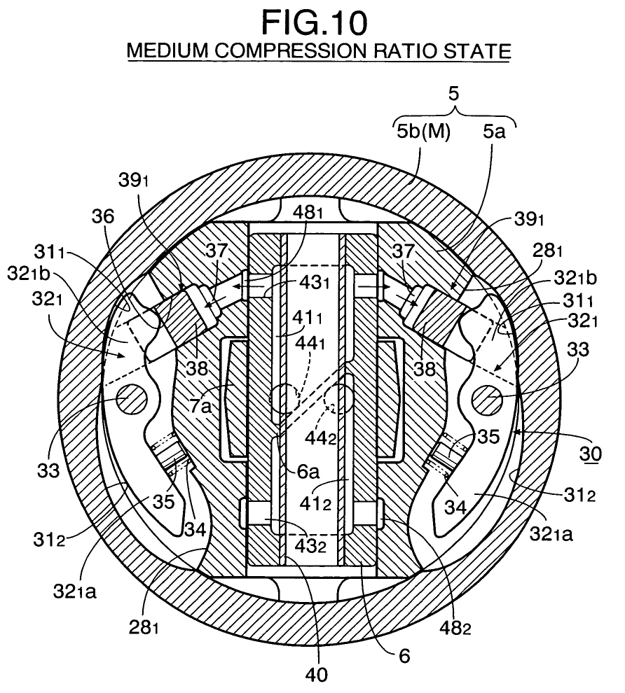

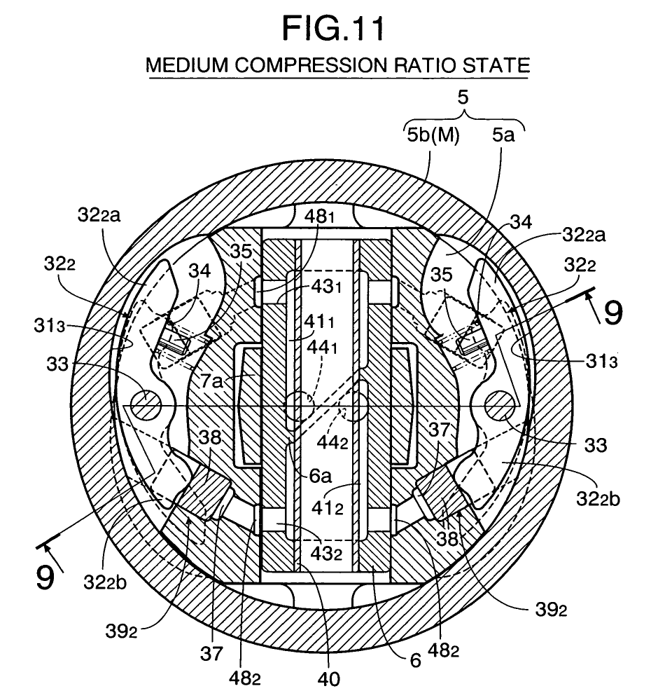

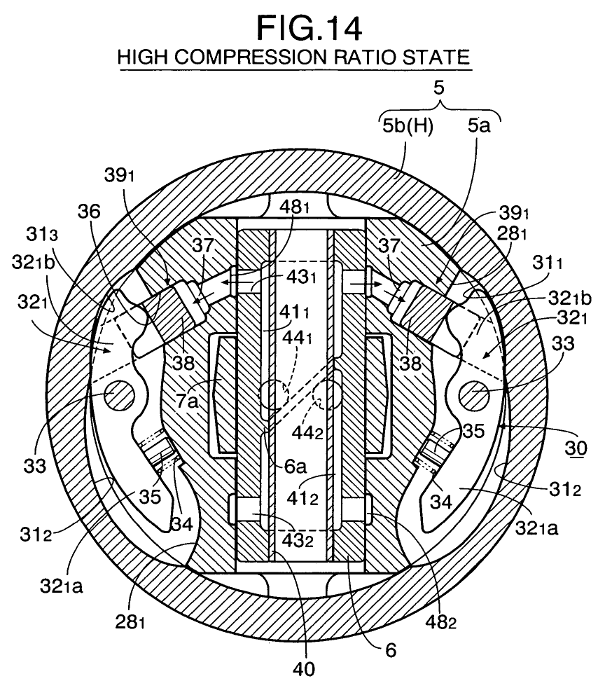

A first embodiment of the present invention is now explained with reference to FIG. 1 to FIG. 21.

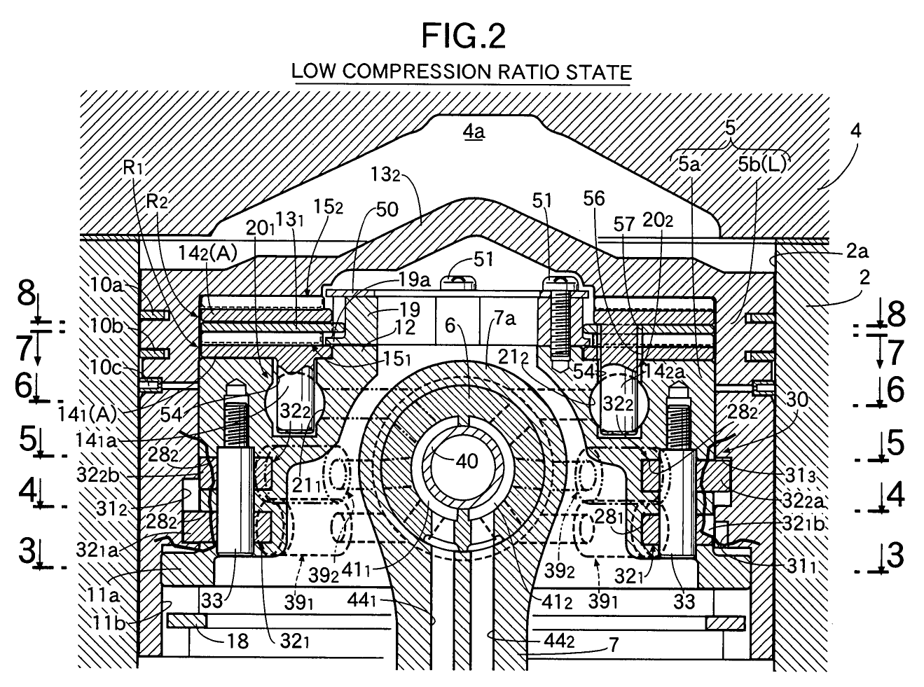

In FIG. 1 and FIG. 2, an engine main body 1 of an internal combustion engine E includes a cylinder block 2 having a cylinder bore 2a, a crankcase 3 joined to the lower end of the cylinder block 2, and a cylinder head 4 joined to the upper end of the cylinder block 2 and having a combustion chamber 4a extending from the cylinder bore 2a. A piston 5 is fitted slidably in the cylinder bore 2a, a little end 7a of a connecting rod 7 is connected to the piston 5 via a piston pin 6, and a big end 7b of the connecting rod 7 is connected to a crankpin 9a of a crankshaft 9 rotatably supported in the crankcase 3 via a pair of left and right bearings 8 and 8′.

The piston 5 includes a piston inner 5a and a piston outer 5b, the piston inner 5a being connected to the little end 7a of the connecting rod 7 via the piston pin 6, and the piston outer 5b, whose top face faces the combustion chamber 4a, being slidably fitted onto an outer peripheral face of the piston inner 5a and into an inner peripheral face of the cylinder bore 2a. A plurality of piston rings 10a to 10c are fitted around the outer periphery of the piston outer 5b, the plurality of piston rings 10a to 10c being in intimate sliding contact with the inner peripheral face of the cylinder bore 2a.

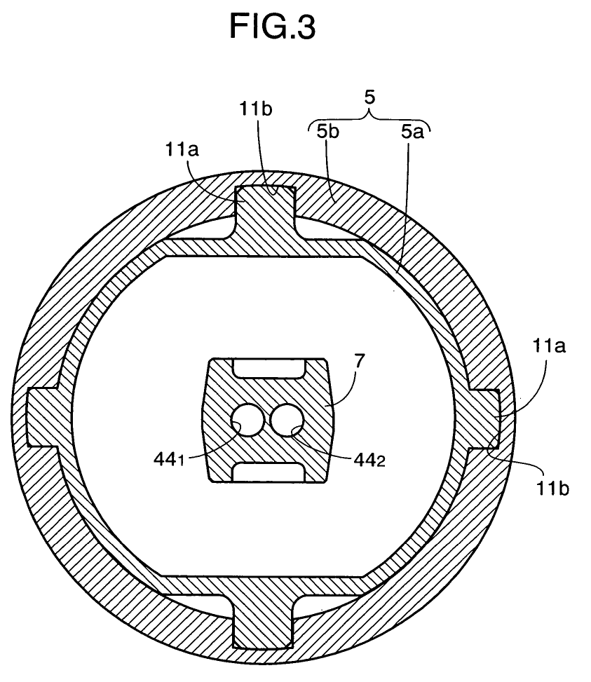

As shown in FIG. 2 and FIG. 3, a plurality of spline teeth 11a and spline grooves 11b extending in the axial direction of the piston 5 and engaging with each other are formed on the sliding mating faces of the piston inner and outer 5a and 5b respectively, thereby preventing relative rotation of the piston inner and outer 5a and 5b around their axes.

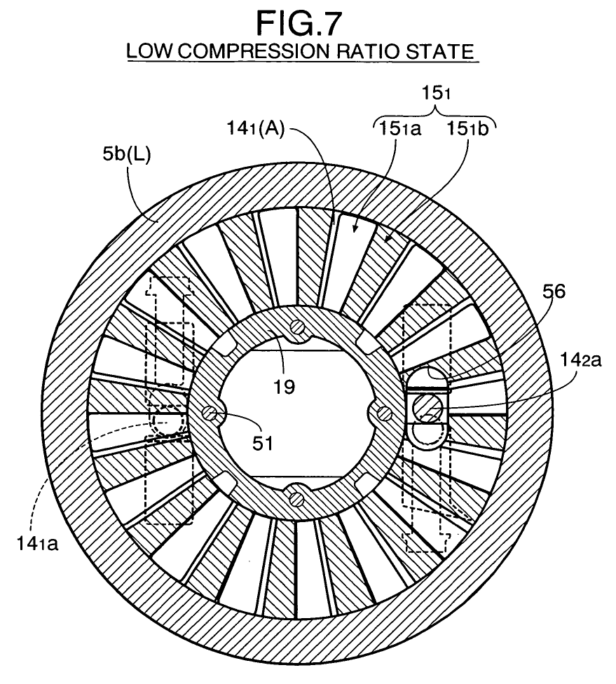

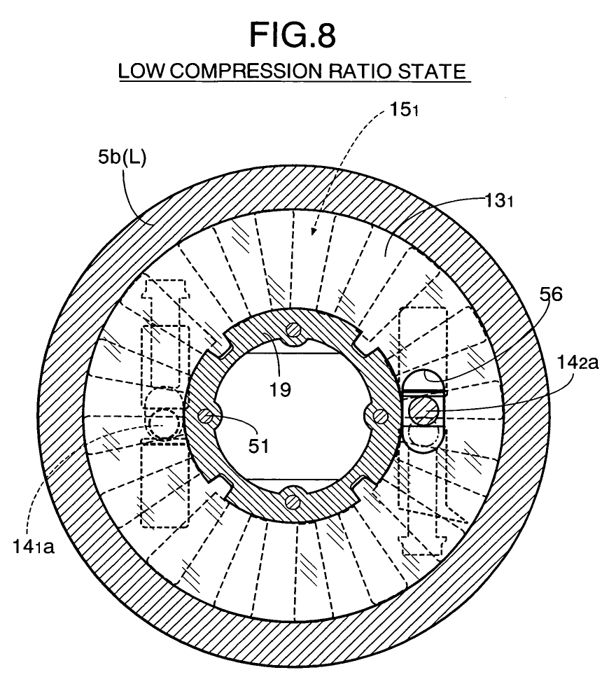

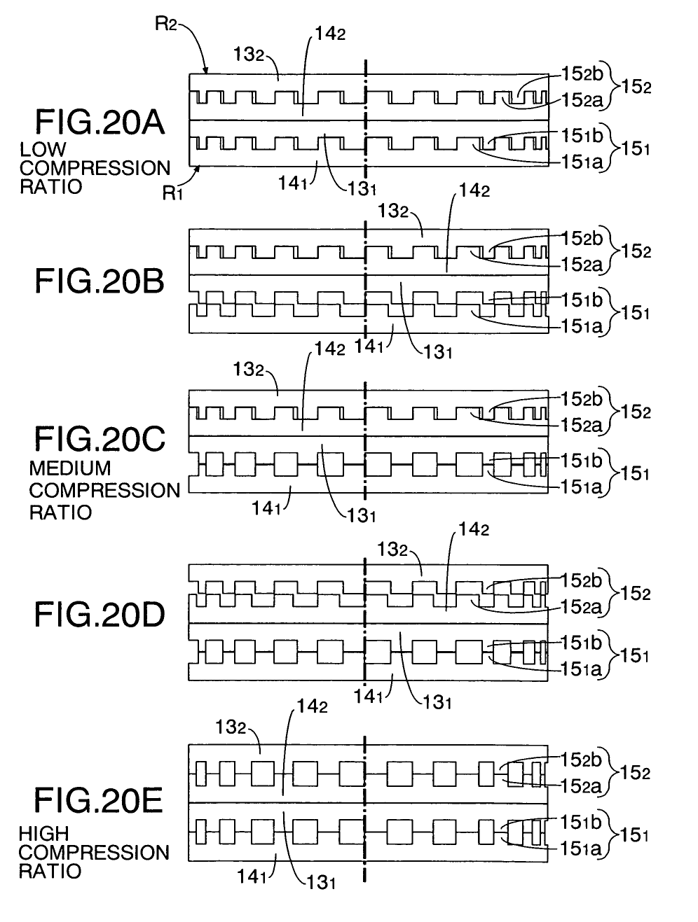

As shown in FIG. 2, FIG. 7, FIG. 8 and FIG. 20A to FIG. 20E, first and second raising means R₁ and R₂ are disposed in line in the axial direction between the piston inner 5a and the piston outer 5b.

The first raising means R₁ is formed from an annular first movable raising member 14₁ pivotably fitted around a pivot portion 12 formed coaxially and integrally on an upper face of the piston inner 5a, and an annular first fixed raising member 13₁ axially and slidably spline-coupled to a cylindrical pivot 19 secured coaxially to an upper end face of the pivot portion 12 by means of screws 51. This first movable raising member 14₁ is capable of reciprocatingly pivoting between a non-raised position A and a raised position B set around the pivot portion 12 on the upper face of the piston inner 5a, and a first cam mechanism 15₁ that can allow the first fixed raising member 13₁ to move up and down along the pivot 19 accompanying the reciprocating pivoting is provided between the first movable raising member 14₁ and the first fixed raising member 1³¹.

As is clear from FIG. 20A to FIG. 20E, the first cam mechanism 15₁ is formed from an upwardly-facing cam 15₁a having peaks and valleys formed on an upper face of the first movable raising member 14₁ and arranged in a rectangular wave shape in the peripheral direction, and a downwardly-facing cam 15₁b similarly having peaks and valleys formed on a lower face of the first fixed raising member 13₁ and arranged in a rectangular wave shape in the peripheral direction; when the first movable raising member 14₁ is at the non-raised position A, the peaks and valleys of the upwardly-facing cam 15₁a mesh with the valleys of the downwardly-facing cam 15¹b, thus allowing the first fixed raising member 13, to move to a downward position; and when the first movable raising member 14₁ is at the raised position B, the peaks of the upwardly-facing cam 15₁a abut against the peaks of the downwardly-facing cam 15₁b, thus holding the first fixed raising member 13₁ in a raised position.

The first raising means R₂ includes an annular second movable raising member 14₁ pivotably and axially slidably fitted around the pivot 12 on a flat upper face of the first fixed raising member 13₁. This second movable raising member 14₁ is capable of reciprocatingly pivoting between a non-raised position A and a raised position B set around the pivot 19 on the upper face of the first fixed raising member 13₁, and a second cam mechanism 15₂ that can allow the piston outer 5b to move up and down accompanying the reciprocating pivoting is provided between the second movable raising member 14₁ and the piston outer 5b.

The second cam mechanism 15₂ is formed from an upwardly-facing cam 15₂a having peaks and valleys formed on an upper face of the second movable raising member 14₁ and arranged in a rectangular wave shape in the peripheral direction, and a downwardly-facing cam 15₂b similarly having peaks and valleys formed on a lower face of a second fixed raising member 13₂, which also serves as a top wall of the piston outer 5b, and arranged in a rectangular wave shape in the peripheral direction; when the second movable raising member 14₁ is at the non-raised position A, the peaks and valleys of the upwardly-facing cam 15₂a mesh with the valleys and peaks of the downwardly-facing cam 15₂b, thus allowing the piston outer 5b to move downward relative to the piston inner 5a; and when the second movable raising member 14₁ is at the raised position B, the peaks of the upwardly-facing cam 15₂a abut against the peaks of the downwardly-facing cam 15₂b, thereby holding the piston outer 5b at a raised position.

The pivot portion 12 is divided into a plurality of blocks arranged at intervals in the peripheral direction so as to accept the little end 7a of the connecting rod 7. A flange 19a is formed at the lower end of the pivot 19, the flange 19a retaining the upper face of the first movable raising member 14₁ and preventing it from becoming detached from the pivot portion 12. Furthermore, a retaining ring 50 is secured to the upper end of the pivot 19 by means of the screws 51, the retaining ring 50 facing the upper face of the second movable raising member 14₁ and preventing it from becoming detached from the pivot 19.

Accordingly, when the first and second movable raising members 14₁ and 14₂ are both controlled so as to be at the non-raised position A, in both of the first and second cam mechanisms 15₁ and 15₂ the peaks and valleys of the upwardly-facing cams 15₁a and 15₂a mesh with the valleys and peaks of the downwardly-facing cams 15₁b and 15₂b, thus controlling the piston outer 5b at a low compression ratio position L in which the piston outer 5b is the closest to the piston inner 5a (see FIG. 20A); when the first movable raising member 14₁ is pivoted to the raised position B while holding the second movable raising member 14₁ at the non-raised position A, in the first cam mechanism 15₁ the peaks of the upwardly-facing cam 15₁a abut against the peaks of the downwardly-facing cam 15₁b, thereby controlling the piston outer 5b at a medium compression ratio position M in which the piston outer 5b is pushed up from the low compression ratio position L toward the combustion chamber 4a by a predetermined distance (see FIG. 20C); and when the second movable raising member 14₁ is also pivoted to the raised position B, in the second cam mechanism 15₂ also the peaks of the upwardly-facing cam 15₂a abut against the peaks of the downwardly-facing cam 15₂b, thereby controlling the piston outer 5b at a high compression ratio position H in which the piston outer 5b is the closest to the combustion chamber 4a (see FIG. 20E).

In the first and second cam mechanisms 15₁ and 15₂, since the upwardly-facing cams 15₁a and 15₂a and the downwardly-facing cams 15₁b and 15₂b are formed in the rectangular wave shape, and the cams are set at a small pitch, it is possible to set at a small value the angle through which each of the movable raising members 14₁ and 14₂ pivots from the non-raised position A to the raised position B, and at the same time it is possible to increase the area of the top face of each peak.

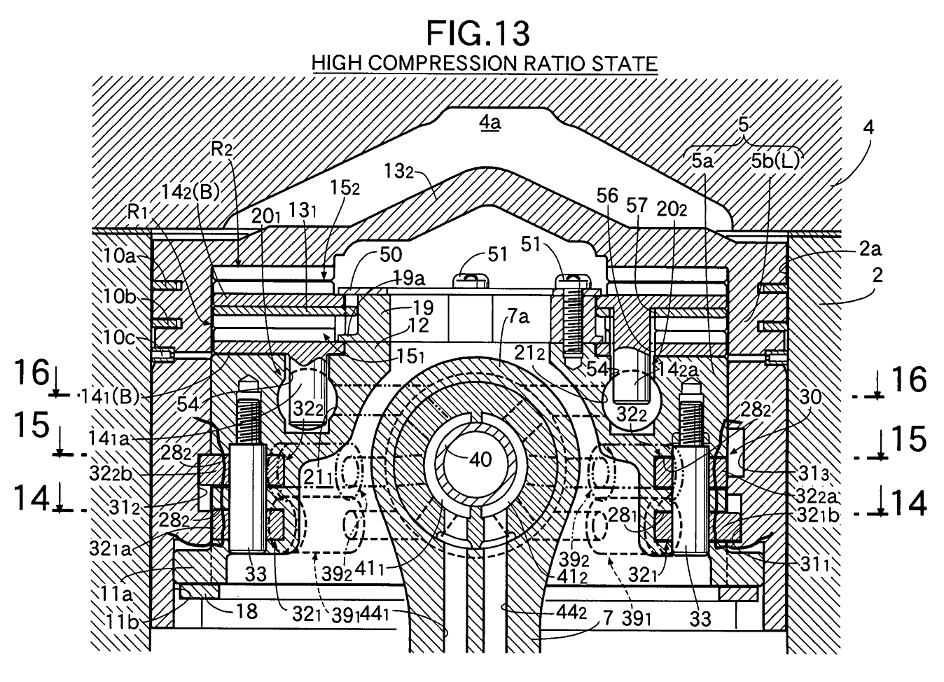

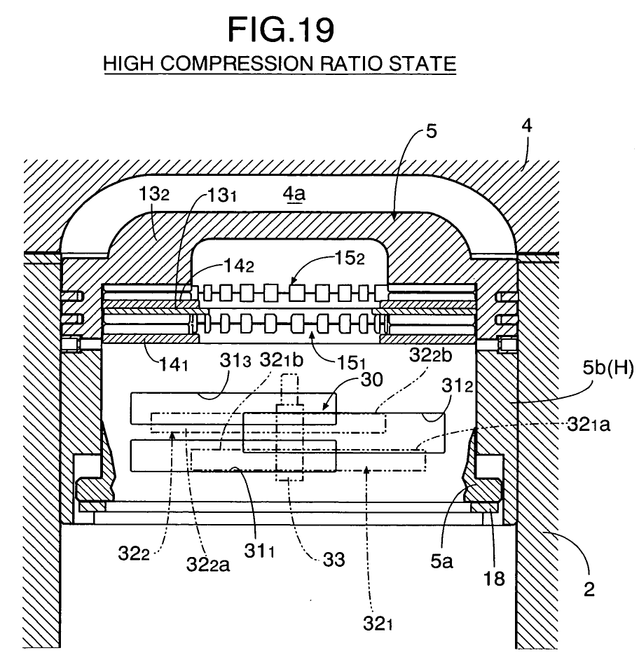

As shown in FIG. 13 and FIG. 19, as restraining means for preventing the piston outer 5b from moving toward the combustion chamber 4a beyond the high compression ratio position H when the piston outer 5b has reached the high compression ratio position H, a stopper ring 18, which abuts against a lower end face of the piston inner 5a, is latched onto an inner peripheral face of a lower end part of the piston outer 5b.

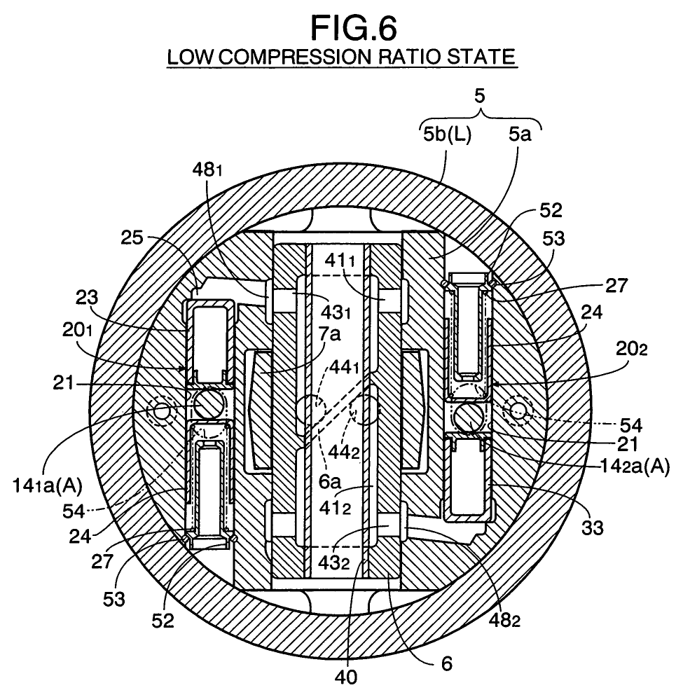

In FIG. 2 and FIG. 6, provided between the piston inner 5a and the first movable raising member 14₁ are a first actuator 20 for alternately pivoting the first movable raising member 14₁ to the non-raised position A and the raised position B, and a second actuator 20₂ for alternately pivoting the second movable raising member 14₁ to the non-raised position A and the raised position B. These first and second actuators 20₁ and 20₂ are now explained.

The first actuator 20₁ includes a cylinder hole 21 bored in one side of the piston inner 5a in parallel to the piston pin 6, and a pressure-bearing pin 14₁a having its extremity facing the cylinder hole 21 through a long hole 54 bored in a lower face of the first movable raising member 14, and running through an upper wall of a middle section of the cylinder hole 21. The long hole 54 is arranged so that there is no interference with movement of the pressure-bearing pin 14₁a, which moves together with the first movable raising member 14₁, between the non-raised position A and the raised position B.

An operating plunger 23 and a return plunger 24 are slidably fitted in the cylinder hole 21 with the pressure-bearing pin 14a disposed therebetween. The return plunger 24 has a bottomed cylindrical shape, a cylindrical retainer 52 fixed to an open end portion of the cylinder hole 21 by means of a retaining ring 53 is inserted into the return plunger 24, and a coil-form return spring 27 is provided in compression between the retainer 52 and the return plunger 24, the return spring 27 urging the return plunger 24 toward the pressure-bearing pin 14₁a.

A hydraulic chamber 25, which the inner end of the operating plunger 23 faces, is formed within the cylinder hole 21; when hydraulic pressure is supplied to the hydraulic chamber 25, the operating plunger 23 receives the hydraulic pressure and pivots the first movable raising member 14₁ to the raised position B via the pressure-bearing pin 14a, and when the hydraulic pressure is released from the hydraulic chamber 25, the return plunger 24 returns the first movable raising member 14₁ to the non-raised position A, via the pressure-bearing pin 14a, by virtue of the urging force of the return spring 27.

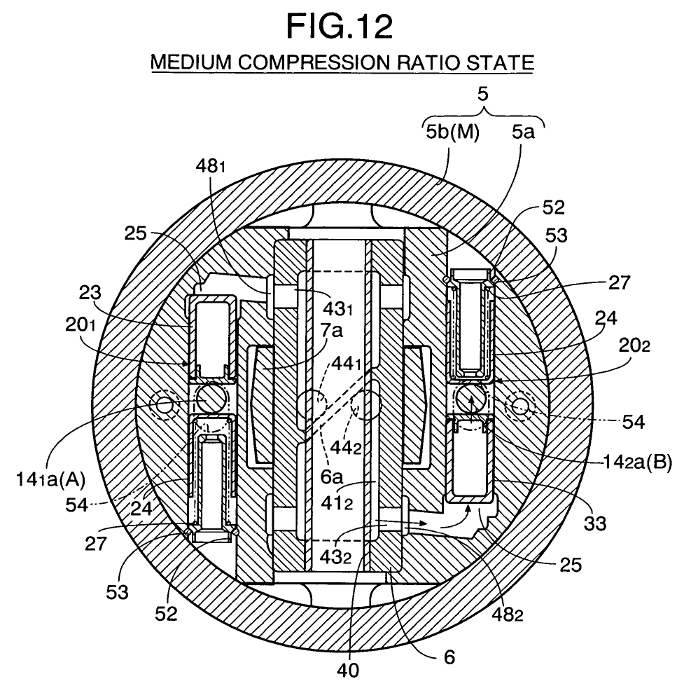

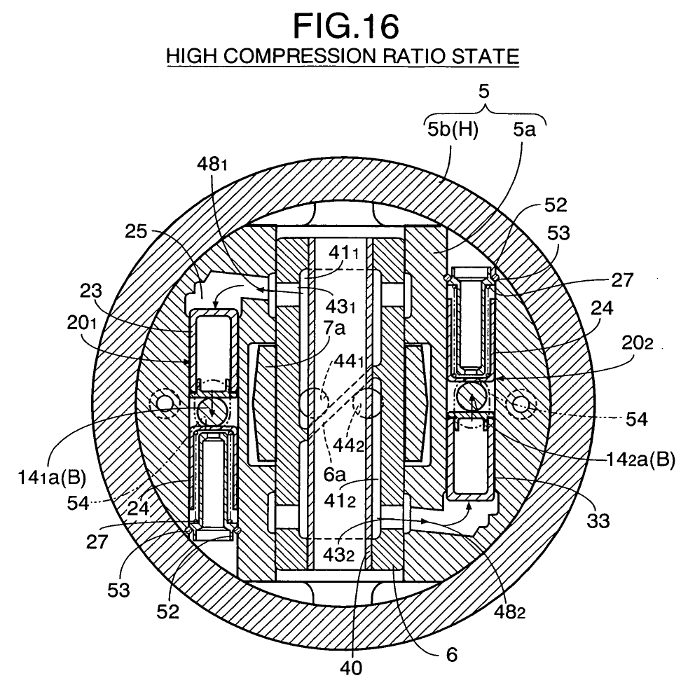

The non-raised position A for the first movable raising member 14₁ is defined by the operating plunger 23 abutting against the base of the cylinder hole 21 as a result of being pushed by the pressure-bearing pin piece 14a (see FIG. 6). The raised position B for the first movable raising member 14₁ is defined by the return plunger 24 abutting against the retainer 52 as a result of being pushed by the pressure-bearing pin piece 14a (see FIG. 12 and FIG. 16).

The second actuator 20₂ has an arrangement that is centrosymmetric with the first actuator 20₁ relative to the axis of the piston inner 5a, and apart from a pressure-bearing pin 14₂a, which is projectingly provided on a lower face of the second movable raising member 14₁, parts of the second actuator 20₂ corresponding to those of the first actuator 20₁ are referred to by the same reference numerals and symbols, and explanation thereof is thus omitted.

In the second actuator 20₂ also, when hydraulic pressure is supplied to a hydraulic chamber 25, an operating plunger 23 receives the hydraulic pressure and pivots the second movable raising member 14₁ to the raised position B via the pressure-bearing pin 14a, and when the hydraulic pressure is released from the hydraulic chamber 25, a return plunger 24 returns the second movable raising member 14₁ to the non-raised position A, via the pressure-bearing pin 14a, by virtue of the urging force of a return spring 27.

Long holes 56 and 57, which are similar to the long hole 54, are bored in the first movable and fixed raising members 14₁ and 13₁ so that there is no interference with movement of the pressure-bearing pin 14₂a of the second actuator 20₂, which moves together with the second movable raising member 14₁, between the non-raised position A and the raised position B.

The first and second actuators 20, and 20₂ allow the piston outer 5b to move between the low compression ratio position L and the high compression ratio position H by virtue of a spontaneous external force such as combustion pressure in the combustion chamber 4a, compression pressure of a gas mixture, inertial force of the piston outer 5b, frictional resistance that the piston outer 5b receives from the inner face of the cylinder bore 2a, intake negative pressure acting on the piston outer 5b, etc., which act so that the piston inner and outer 5a and 5b are moved toward or away from each other in the axial direction.

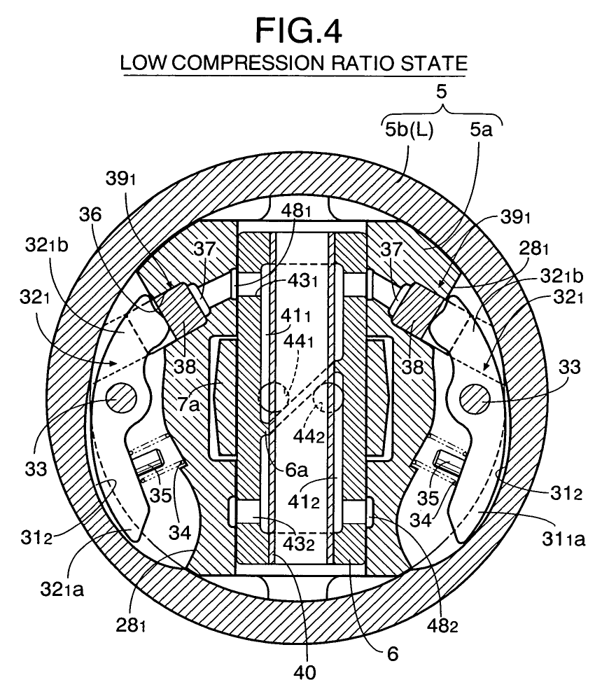

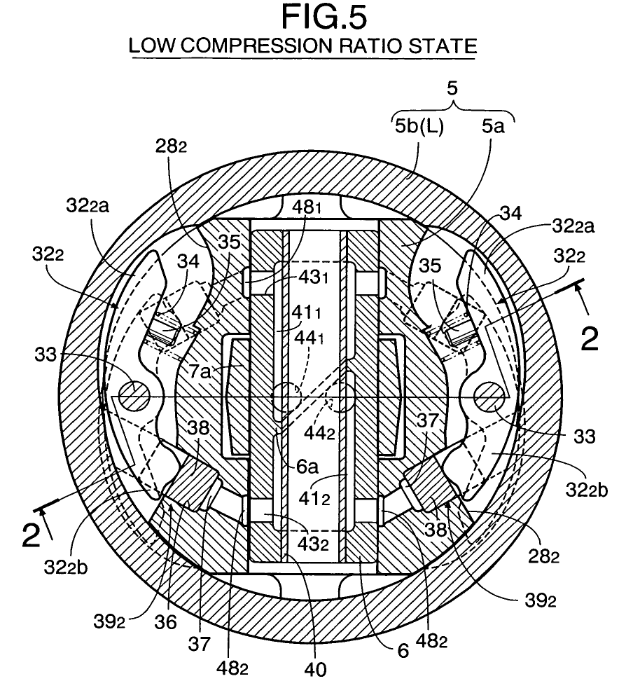

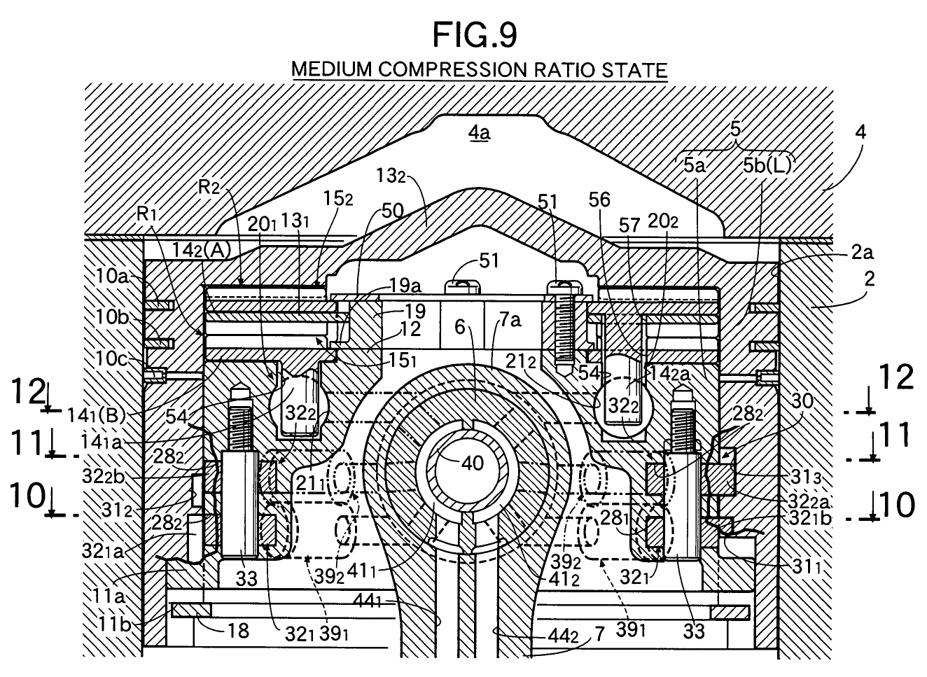

Piston outer latching means 30 is provided between the piston inner 5a and the piston outer 5b, the piston outer latching means 30 latching the piston outer 5b at three positions, that is, the low compression ratio position L, the medium compression ratio position M, and the high compression ratio position H. The piston outer latching means 30 is explained with reference to FIG. 2, FIG. 4, FIG. 5, and FIG. 9 to FIG. 20E.

As shown in FIG. 2 and FIG. 20A to FIG. 20E, three sets of two latching channels 31₁ to 31₃ extending in the peripheral direction and arranged vertically are formed in the inner peripheral face of the piston inner 5a so that the channels of each set face each other, and the sets of latching channels are called, from the bottom to the top, the first latching channels 31₁, the second latching channels 31₂, and the third latching channels 31₃. The first and third latching channels 31₁ and 31₃ are arranged in phase, and the second latching channels 31₂ are displaced in the peripheral direction of the piston outer 5b relative to the first and third latching channels 31₁ and 31₃ while partially overlapping the first and third latching channels 31₁ and 31₃. The piston inner 5a has provided in its outer peripheral wall two sets of lower and upper housing grooves 28₁ and 28₂ extending in the peripheral direction so as to sandwich the piston pin 6; in each of the lower housing grooves 28, a first latching lever 32, is swingably mounted on the piston inner 5a via a pivot shaft 33 parallel to the axis of the piston inner 5a, and in each of the upper housing grooves 28₂ a second latching lever 32₂ is swingably mounted on the piston inner 5a via the pivot shaft 33. The first and second latching levers 32₁ and 32₂ include a long arm 32a and a short arm 32b extending from the swing center in opposite directions from each other, the long arm 32a of the first latching lever 32₁ and the short arm 32b of the second latching lever 32₂ can engage with the second latching channel 31₂, and the short arm 32b of the first latching lever 32₁ and the long arm 32a of the second latching lever 32₂ can engage with the first and third latching channels 31₁ and 31₃ respectively. The channel width of the first and third latching channels 31₁ and 31₃ is set to be larger than the thickness of the first and second latching levers 32₁ and 32₂ by an amount corresponding to the amount of lift of the piston outer 5b by the first or second raising means R₁ or R₂, and the channel width of the second latching channel 31₂ is set to be yet larger.

First and second driving means 39₁ and 39₂ are connected to the first and second latching levers 32₁ and 32₂ and swing them individually.

The first driving means 39₁ is formed from a coil-form operating spring 34 that is disposed between the base of the lower housing groove 28, and the long arm 32a of the first latching lever 32₁ and urges the long arm 32a in a direction in which it is engaged with the second latching channel 31₂, and a hydraulic piston 38 that is fitted into a cylinder hole 36 formed in the piston inner 5a and abuts against the tip of the second arm 32b of the first latching lever 32₁ so as to push it toward the second latching channel 31₂. In this arrangement, a positioning projection 35 is formed on the long arm 32a of the first latching lever 32₁ so as to prevent the operating spring 34 from moving around. A hydraulic chamber 37, which the inner end of the hydraulic piston 38 faces, is defined in the cylinder hole 36.

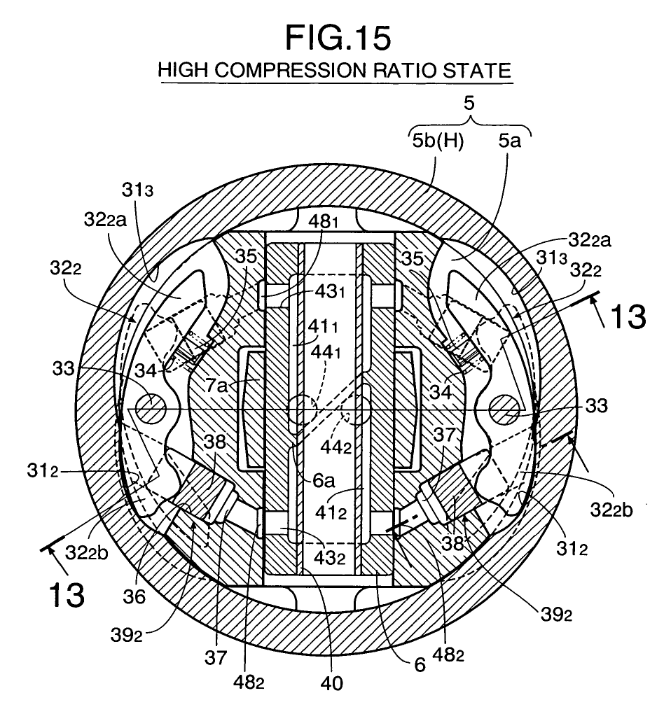

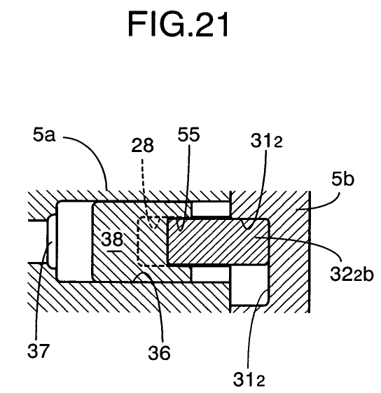

As shown in FIG. 15 and FIG. 21 in particular, the cylinder holes 36 of the piston inner 5a are formed by cutting away opposite side walls of each of the housing grooves 28₁ and 28₂ at a diameter larger than that of the groove width of each of the housing grooves 28₁ and 28₂ so that the cylinder holes 36 open on an outer peripheral face of the piston inner 5a, and the tips of the hydraulic pistons 38 fitted into the cylinder holes 36 are provided with cutouts 55 that receive the tips of the second arms 32₁b and 32₂b of the latching levers 32₁ and 32₂. Therefore, even when a part of the hydraulic pistons 38 is exposed within the housing grooves 28, and 28₂, since the whole length of the hydraulic pistons 38 can be supported on the inner peripheral face of the cylinder holes 36, and the load of the short arms 32₁b and 32₂b act on an axially middle point of the hydraulic pistons 38, the operation of the hydraulic pistons 38 can be stabilized.

Since the second driving means 39₂ has basically the same arrangement as that of the first driving means 39₁, parts of the second driving means 39₂ corresponding to those of the first driving means 39₁ are referred to using the same reference numerals and symbols, and detailed explanation thereof is omitted. This second driving means 39₂ is arranged so that an operating spring 34 urges the long arm 32₁a of the first latching lever 32₁ in a direction in which it engages with the third latching channel 31₃, and when the hydraulic piston 38 receives hydraulic pressure, it pushes the short arm 32₂b of the second latching lever 32₂ in a direction in which it engages with the second latching channel 31₂.

Accordingly, when the piston outer 5b comes to the low compression ratio position L, when the hydraulic pressure is released from the hydraulic chamber 37 in the first driving means 39₁, the long arm 32₁a of the first latching lever 32₁ engages with the second latching channel 31₂ and abuts against a lower face of the latching channel 31₂ by virtue of the urging force of the operating spring 34, thus holding the piston outer 5b at the low compression ratio position L.

When the piston outer 5b comes to the medium compression ratio position M, hydraulic pressure is supplied to the hydraulic chamber 37 in the first driving means 39₁ so as to move the hydraulic piston 38, the short arm 32₁b of the first latching lever 32₁ engages with the first latching channel 31₁ and abuts against an upper face of the latching channel 31₁, and at the same time hydraulic pressure is released from the hydraulic chamber 37 in the second driving means 39₂, and the long arm 32₂a of the second latching lever 32₂ engages with the third latching channel 31₃, and abuts against a lower face of the latching channel 31₃ by virtue of the urging force of the operating spring 34, thereby holding the piston outer 5b at the medium compression ratio position M.

When the piston outer 5b comes to the high compression ratio position H, hydraulic pressure is supplied to the hydraulic chamber 37 of the second driving means 39₂ so as to move the hydraulic piston 38, the short arm 32₂b of the second latching lever 32₂ engages with the second latching channel 31₂, and abuts against an upper face of the latching channel 31₂, which in cooperation with the stopper ring 18 of the piston outer 5b abutting against the lower end face of the piston inner 5a, holds the piston outer 5b at the high compression ratio position H.

Referring again to FIG. 1, FIG. 2, and FIG. 4 to FIG. 6, tubular first and second oil chambers 41₁ and 41₂ are defined between the piston pin 6 and a sleeve 40 press-fitted in a hollow portion thereof, the first and second oil chambers 41₁ and 41₂ being separated by a dividing wall 6a. The first oil chamber 41₁ communicates with the hydraulic chamber 37 of the first actuator 20₁ and the hydraulic chamber 37 of the first driving means 39₁ via a plurality of first side holes 43₁ in one end portion of the piston pin 6 and a first annular oil passage 48₁ surrounding the first side holes 43₁, and the second oil chamber 41₂ communicates with the hydraulic chamber 25 of the second actuator 20₂ and the hydraulic chamber 37 of the second driving means 39₂ via a plurality of second side holes 43₂ in the other end portion of the piston pin 6 and a second annular oil passage 48₂ surrounding the second side holes 43₂.

The first and second oil chambers 41₁ and 41₂ are also connected to first and second oil passages 44₁ and 44₂ provided so as to extend over the piston pin 6, the connecting rod 7, and the crankshaft 9, and these first and second oil passages 44₁ and 44₂ are switchably connected via first and second solenoid switch valves 45₁ and 45₂ to an oil pump 46, which is a common hydraulic pressure source, and an oil reservoir 47.

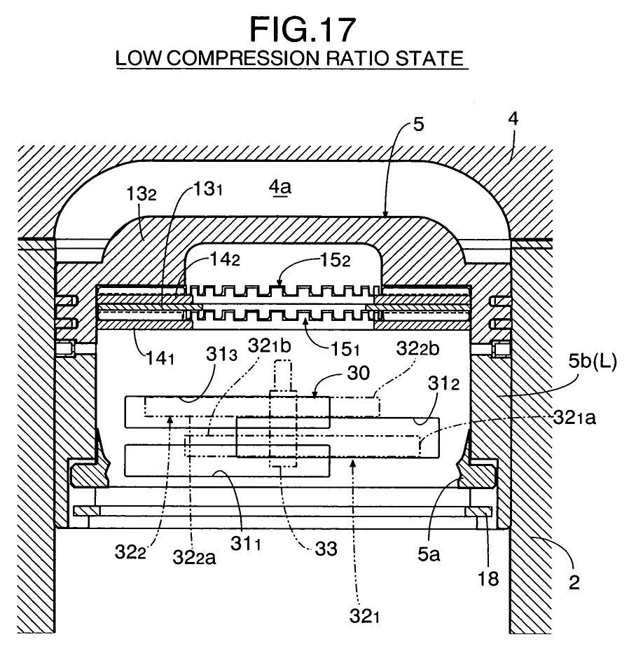

The operation of the first embodiment is now explained.

<Control for Low Compression Ratio> (see FIG. 1 to FIG. 8, FIG. 17 and FIG. 20A to FIG. 20E)

When, for example, the internal combustion engine E is being rapidly accelerated, to obtain a low compression ratio state in order to avoid knocking, as shown in FIG. 1 the first and second solenoid switch valves 45₁ and 45₂ are put in a nonenergized state, and both the first and second oil passages 44₁ and 44₂ are opened to the oil reservoir 47. By so doing, since the hydraulic chambers 25 of the first and second actuators 20₁ and 20₂ and the hydraulic chambers 37 of the first and second driving means 39₁ and 39₂ are all open to the oil reservoir 47, then as shown in FIG. 4 to FIG. 6 and FIG. 17, in both the first and second actuators 20₁ and 20₂, the return plungers 24 apply a force, due to the urging forces of the return springs 27, that rotates the first and second movable raising members 14₁ and 14₂ toward the non-raised positions A via the pressure-bearing pins 14₁a and 14₁b. Furthermore, in both the first and second driving means 39₁ and 39₂, the operating springs 34 urge, by virtue of their urging forces, the long arms 32₁a and 32₂a of the first and second latching levers 32₁ and 32₂, which are axially supported on the piston inner 5a, toward the inner peripheral face of the piston outer 5b.

As a result, as shown in FIG. 20A, since the upwardly-facing cams 15₁a and 15₂a and the downwardly-facing cams 15₁b and 15₂b are in a phase in which they can mesh with each other in both the first and second cam mechanisms 15₁ and 15₂, when the piston outer 5b is pushed against the piston inner 5a by means of the pressure on the combustion chamber 4a side during the engine expansion stroke or compression stroke, when the piston outer 5b is pushed against the piston inner 5a by means of frictional resistance occurring between the piston rings 10a to 10c and the inner face of the cylinder bore 2a during the upward stroke of the piston 5, or when the piston outer 5b is pushed against the piston inner 5a by virtue of the inertial force of the piston outer 5b accompanying deceleration of the piston inner 5a during the second half of the downward stroke of the piston 5, the piston outer 5b is able to descend relative to the piston inner 5a down to the low compression ratio position L while making the upwardly-facing cams 15₁a and 15₂a and the downwardly-facing cams 15₁b and 15₂b of the first and second cam mechanisms 15₁ and 15₂ mesh with each other. In this way, when the piston outer 5b reaches the high compression ratio position H, the position of the long arm 32₁a of the first latching lever 32₁ axially supported on the piston inner 5a and the position of the second latching channel 31₂ of the piston outer 5b are aligned, and the long arm 32₁a engages with the second latching channel 31₂ by virtue of the urging force of the operating spring 34 and abuts against the lower face of the latching channel 31₂, thereby holding the piston outer 5b at the low compression ratio position L. During this process, the short arm 32₁b of the first latching lever 32₁ is withdrawn inside the piston inner 5a. In this way, there is no play in the axial direction in the first and second cam mechanisms 15₁ and 15₂, and the piston inner and outer 5a and 5b can move up and down within the cylinder bore 2a as a unit while giving a low compression ratio.

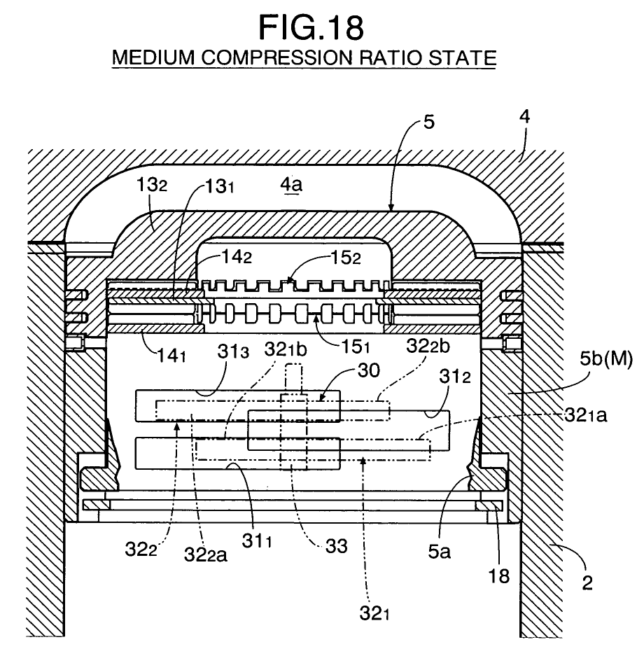

On the other hand, the long arm 32₂a of the second latching lever 32₂ engages with the third latching channel 31₃ of the piston inner 5a, thus preparing for movement to a subsequent medium compression ratio state. During this process, the short arm 32₂b of the second latching lever 32₂ is also withdrawn inside the piston inner 5a.

<Control for Medium Compression Ratio> (see FIG. 9 to FIG. 12, FIG. 18 and FIG. 20A to FIG. 20E)

Subsequently, for example, to obtain a medium compression ratio state in order to improve the output when the internal combustion engine E is running at medium speed, the first solenoid switch valve 45₁ is energized, thus connecting the first oil passage 44₁ to the oil pump 46. By so doing, hydraulic pressure from the oil pump 46 is supplied to the hydraulic chamber 25 of the first actuator 20₁ and the hydraulic chamber 37 of the first driving means 39₁ via the first oil passage 44₁, and as shown in FIG. 12, in the first actuator 20₁ the operating plunger 23 applies a force, due to the hydraulic pressure of the hydraulic chamber 25, that rotates the first movable raising member 14₁ to the raised position B via the pressure-bearing pin 14₁a of the first raising means R₁. In the first driving means 39₁, the hydraulic piston 38 pushes the short arm 32₁b of the first latching lever 32₁ toward the inner peripheral face of the piston inner 5a due to the hydraulic pressure of the hydraulic chamber 37 while withdrawing the long arm 32₁a inside the piston inner 5a. As a result, the piston outer 5b is allowed to move to the medium compression ratio position M.

The piston outer 5b moves to the medium compression ratio position M upon receiving the following types of spontaneous external force. That is, when the piston outer 5b is drawn toward the combustion chamber 4a by virtue of the intake negative pressure during the engine intake stroke, when the piston outer 5b is left behind from the piston inner 5a by virtue of frictional resistance occurring between the piston rings 10a to 10c and the inner face of cylinder bore 2a during the downward stroke of the piston 5, or when the piston outer 5b attempts to become detached from the piston inner 5a by virtue of the inertial force of the piston outer 5b accompanying deceleration of the piston inner 5a during the second half of the upward stroke of the piston 5, the piston outer 5b rises from the piston inner 5a, and when it reaches the medium compression ratio position M, the lower face of the third latching channel 31₃ abuts against the long arm 32₂a of the second latching lever 32₂, which has already been engaged with the third latching channel 31₃, thereby preventing the piston outer 5b from ascending beyond the medium compression ratio position M. At the same time, since the position of the short arm 32₁b of the first latching lever 32₁ and the position of the first latching channel 31₁ are aligned, the short arm 32₁b of the first latching lever 32₁, which is pushed toward the inner peripheral face of the piston inner 5a by the hydraulic piston 38 of the first driving means 39₁, engages with the first latching channel 31₁ and abuts against the upper face of the latching channel 31₁. A dividing wall between the first and third latching channels 31₁ and 31₃ is therefore held from above and below between the short arm 32₁b of the first latching lever 32₁ and the long arm 32₂a of the second latching lever 32₂, thereby latching the piston outer 5b at the medium compression ratio position M.

In this way, the piston outer 5b is held at the medium compression ratio position M, and as shown in FIG. 20B as soon as the upwardly-facing cam 15₁a and the downwardly-facing cam 15₁b of the first cam mechanism 15, are disengaged from each other, the first movable raising member 14₁ is pivoted to the raised position B by the pushing force from the operating plunger 23 of the first actuator 20₁. As a result, as shown in FIG. 20C, the peaks of the upwardly-facing cam 15₁a and the downwardly-facing cam 15₁b of the first cam mechanism 15₁ abut against each other, thereby firmly holding the piston outer 5b at the medium compression ratio position M.

<Control for High Compression Ratio> (see FIG. 13 to FIG. 16, FIG. 19 and FIG. 20A to FIG. 20E)

To obtain a high compression ratio state in order to further increase the compression ratio of the internal combustion engine E, the second solenoid switch valve 45₂ is also energized while maintaining the energized state of the first solenoid switch valve 45₁, thus connecting the second oil passage 44₂ to the oil pump 46. By so doing, since hydraulic pressure from the oil pump 46 is also supplied to the hydraulic chamber 25 of the second actuator 20₂ and the hydraulic chamber 37 of the second driving means 39₂ via the second oil passage 44₂, as shown in FIG. 16, in the second actuator 20₂ also the operating plunger 23 applies a force, due to the hydraulic pressure of the hydraulic chamber 25, to rotate the second movable raising member 14₁ to the raised position B via the pressure-bearing pin 14₁a of the second raising means R₂. In the first driving means 39₁ also, the hydraulic piston 38 pushes the short arm 32₂b of the second latching lever 32₂ by means of the hydraulic pressure of the hydraulic chamber 37 toward the inner peripheral face of the piston inner 5a while withdrawing the long arm 32₂a inside the piston inner 5a. As a result, the piston outer 5b is allowed to move to the high compression ratio position H.

When the piston outer 5b moves up to the high compression ratio position H as a result of receiving a spontaneous external force similar to those when the piston outer 5b moves to the medium compression ratio position M, the stopper ring 18 at the lower end part of the piston outer 5b abuts against the lower end face of the piston inner 5a, thereby stopping the ascent of the piston outer 5b at a predetermined high compression ratio position H. At the same time, since the position of the short arm 32₂b of the second latching lever 32₂ and the position of the second latching channel 31₂ are aligned, the short arm 32₂b engages with the second latching channel 31₂ by virtue of the pushing force of the hydraulic piston 38 of the second driving means 39₂, and abuts against the upper face of the latching channel 31₂. Therefore, even when the piston outer 5b receives a kick due to impulsive contact of the stopper ring 18 against the lower end face of the piston inner 5a, since the kick is borne by the short arm 32₂b of the second latching lever 32₂, the piston outer 5b can be prevented from bouncing back from the high compression ratio position H and can be held reliably at the high compression ratio position H.

In this way, the piston outer 5b reaches the high compression ratio position H and, as shown in FIG. 20D, as soon as the upwardly-facing cam 15₂a and the downwardly-facing cam 15₂b of the second cam mechanism 15₂ are disengaged from each other, the second movable raising member 14₁ is also pivoted to the raised position B by virtue of the pushing force of the operating plunger 23 of the second actuator 20₂. As a result, as shown in FIG. 20E the second cam mechanism 15₂ makes the top faces of the peaks of the upwardly-facing cam 15₂a and the downwardly-facing cam 15₂b abut against each other in the same manner as in the first cam mechanism 15₁, thus firmly holding the piston outer 5b at the high compression ratio position H.

In this way, there is no play in the axial direction in the first and second cam mechanisms 15₁ and 15₂, and the piston inner and outer 5a and 5b move up and down within the cylinder bore 2a as a unit while maximizing the compression ratio.

As hereinbefore described, by pivoting the first and second movable raising members 14₁ and 14₂ between just two positions, that is, the non-raised position A and the raised position B, it is possible to switch the position of the piston outer 5b appropriately between the three stages, that is, the low compression ratio position L, the medium compression ratio position M, and the high compression ratio position H, thereby enabling a close correspondence with various running conditions of the internal combustion engine E.

Moreover, when the piston outer 5b is controlled at the low compression ratio position L, the medium compression ratio position M, or the high compression ratio position H, since rotation thereof relative to the piston inner 5a is restricted by the spline teeth 11a and the spline grooves 11b formed on the mating faces of the piston inner 5a and the piston outer 5b and slidably engaging with each other, it is possible to make the shape of the top face of the piston outer 5b, which faces the combustion chamber 4a, match the shape of the combustion chamber 4a, thus enabling the compression ratio at the high compression ratio position H of the piston outer 5b to be increased effectively.

Moreover, when the piston outer 5b is at the medium compression ratio position M or the high compression ratio position H, since a large thrust that the piston outer 5b receives from the combustion chamber 4a during the engine expansion stroke acts perpendicularly on the flat top face of the peaks of the upwardly-facing cams 15₁a and 15₂a and the downwardly-facing cams 15₁b and 15₂b of the first cam mechanism 15₁ and/or the second cam mechanism 15₂, the flat top faces abutting against each other, the first movable raising member 14, and/or the second movable raising member 14₁ are not pivoted by the thrust. As a consequence, the hydraulic pressure supplied to the hydraulic chambers 25 of the first and second actuators 20₁ and 20₂ does not need to have such a high pressure as to be able to counterbalance the thrust and, furthermore, even when there are some bubbles in the hydraulic chambers 25, since the piston outer 5b can be held stably at the medium compression ratio position M and the high compression ratio position H, there are no problems.

Moreover, since movement of the piston outer 5b between the low compression ratio position L, the medium compression ratio position M, and the high compression ratio position H utilizes a spontaneous external force, which acts on the piston inner and outer 5a and 5b during reciprocation of the piston 5 so as to make the piston inner and outer 5a and 5b move toward or away from each other in the axial direction, the first and second actuators 20₁ and 20₂ are required only to exhibit an output for simply pivoting the first and second movable raising members 14₁ and 14₂ between the non-raised position A and the raised position B, thereby enabling the capacity and dimensions of the first and second actuators 20₁ and 20₂ to be reduced.

Among the above-mentioned spontaneous external forces, the frictional resistance between the piston rings 10a to 10c and the inner face of the cylinder bore 2a and the inertial force of the piston outer 5b are particularly effective. Since the above-mentioned frictional resistance changes relatively little in response to a change in rotational speed of the engine whereas the inertial force of the piston outer 5b increases in response to an increase in the rotational speed of the engine in the manner of a quadratic curve, for switching the position of the piston outer 5b the frictional resistance is dominant in a low rotational speed region of the engine, and the inertial force of the piston outer 5b is dominant in a high rotational speed region of the engine.

Furthermore, since the hydraulic chamber 25 of the first actuator 20₁ and the hydraulic chamber 37 of the first driving means 39, are connected switchably to the oil pump 46 and the oil reservoir 47 via the common first solenoid switch valve 45₁, and the hydraulic chamber 25 of the second actuator 202 and the hydraulic chamber 37 of the second driving means 392 are connected switchably to the oil pump 46 and the oil reservoir 47 via the common second solenoid switch valve 452, the two actuators 20₁ and 20₂ and the two driving means 39₁ and 39₂ can be operated efficiently with common hydraulic pressure, the hydraulic pressure circuit can be simplified, and the variable compression ratio system can be provided at low cost.

Furthermore, since the operating plunger 23 and the return plunger 24, which are components of each of the first and second actuators 20₁ and 20₂, are fitted in the common cylinder hole 21 formed in the piston inner 5a, the structure is simple, and machining of the holes is easy, thus contributing to a reduction in cost.

Moreover, since each of the cylinder holes 21 of the first and second actuators 20₁ and 20₂ is formed in the piston inner 5a in parallel to the piston pin 6, which is disposed therebetween, the first and second actuators 20₁ and 20₂ can be arranged in the confined interior of the piston inner 5a without interfering with the piston pin 6.

Furthermore, since the axes of the operating and return plungers 23 and 24 of the first and second actuators 20₁ and 20₂ are arranged so as to be substantially orthogonal to a pivot 19 radius that intersects the axis of the corresponding pressure-bearing pins 14₁a and 14₂a, the pushing forces of the operating and return plungers 23 and 24 can be transmitted efficiently to the first and second raising members 14₁ and 14₂ via the pressure-bearing pins 14₁a and 14₂a, thus contributing to making the actuators 20₁ and 20₂ compact.

Moreover, since end faces of the operating and return plungers 23 and 24 are in line contact with a cylindrical outer peripheral face of the pressure-bearing pins 14₁a and 14₂a, the contact area is relatively large, thus decreasing the plane pressure and contributing to an improvement in the durability.

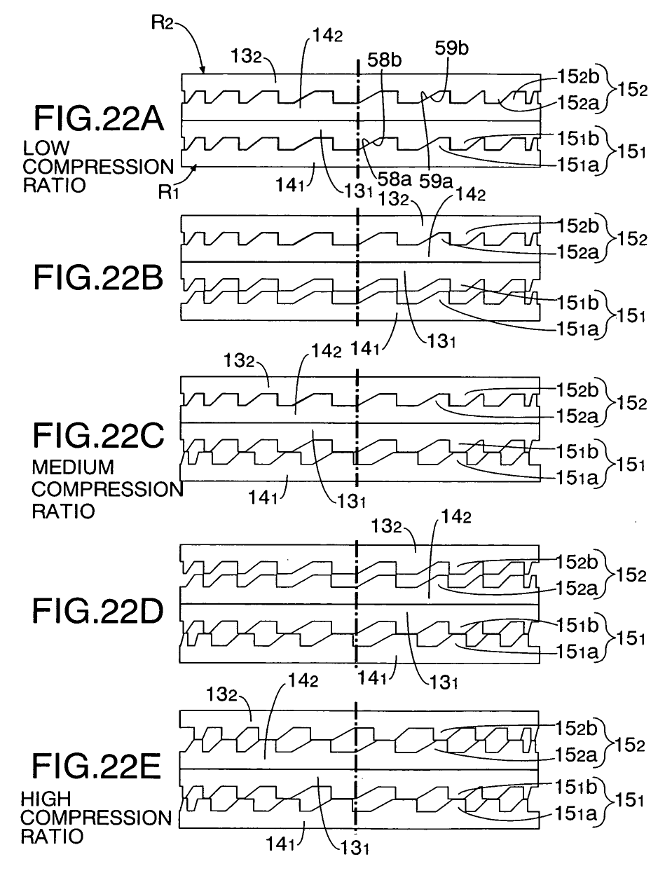

A second embodiment of the present invention is now explained with reference to FIG. 22A to FIG. 22E.

The second embodiment has the same arrangement as that of the preceding embodiment except that one side face of each peak of first and second cam mechanisms 15₁ and 15₂ is provided with inclined faces 58a, 58b; 59a, 59b which slide away from each other in the axial direction when first and second movable raising members 14₁ and 14₂ pivot from a non-raised position A to a raised position B, and in FIG. 21 parts corresponding to the parts of the preceding embodiment are denoted by the same reference numerals and symbols, thereby avoiding duplication of the explanation.

In the second embodiment, since one side of each peak of the first and second cam mechanisms 15₁ and 15₂ is the inclined face 58a, 58b; 59a, 59b, compared with the preceding embodiment the pitch of the peaks is widened, the operating stroke angle of the first and second raising members 14₁ and 14₂ increases, and the area of the top face of each of the peaks decreases, but even when the spontaneous external force for moving the piston outer 5b to a medium compression ratio position M or a high compression ratio position H is weak, if a pivoting force is applied to the first and second raising members 14₁ and 14₂ by means of first and second actuators, which are not illustrated, the mutual lifting action of the inclined faces 58a, 58b; 59a, 59b enables the piston outer 5b to be pushed up to the medium compression ratio position M or the high compression ratio position H.

The present invention is not limited to the above-mentioned embodiments, and can be modified in a variety of ways without departing from the spirit and scope of the present invention. For example, by changing the height of the peaks of the first and second cam mechanisms 15₁ and 15₂, a mode in which the first movable raising member 14₁ is held at the non-raised position A and the second movable raising member 14₁ is pivoted to the raised position B is added, thereby enabling the piston outer 5b to be controlled at four stages, that is, a low compression ratio position, a first medium compression ratio position, a second medium compression ratio position, and a high compression ratio position. Furthermore, the operating mode of the first and second solenoid switch valves 45₁ and 45₂ can be the opposite of that of the above-mentioned embodiments. That is, an arrangement is possible in which, when the switch valves 45₁ and 45₂ are in a nonenergized state, the first and second oil passages 44₁ and 44₂ are connected to the oil pump 46, and when they are in an energized state, the oil passages 44₁ and 44₂ are connected to the oil reservoir 47.

Furthermore, if the set load for the return spring 27 of the first actuator 20₁ is set to be lower than the set load for the return spring 27 of the second actuator 20₂, the set load for the operating spring 34 of the first driving means 39₁ is set to be lower than the set load for the operating spring 34 of the second driving means 39₂, the first and second oil passages 44₁ and 44₂ are combined into a common single oil passage, this common single oil passage is provided with a common single switch valve, and hydraulic pressure control means is also provided that can control the hydraulic pressure of the oil passage at a first hydraulic pressure at which the first actuator 20₁ and the first driving means 39₁ can be operated hydraulically and a second hydraulic pressure at which the second actuator 20₂ and the second driving means 39₂ can be operated hydraulically, it is thereby possible to carry out operation of the first and second actuators 20₁ and 20₂ in sequence and operation of the first and second driving means 39₁ and 39₂ in sequence by means of a simple hydraulic pressure circuit.

1. An internal combustion engine variable compression ratio system comprising a piston inner (5a) connected to a connecting rod (7) via a piston pin (6), a piston outer (5b) that, while being fitted around the outer periphery of the piston inner (5a) so that the piston outer (5b) can slide only in the axial direction and having an outer end face facing a combustion chamber (4a), is capable of moving to a low compression ratio position (L) close to the piston inner (5a), a high compression ratio position (H) close to the combustion chamber (4a), and at least one medium compression ratio position (M) between the low compression ratio position (L) and the high compression ratio position (H), and at least two sets of raising means (R₁, R₂) disposed in line in the axial direction between the piston inner (5a) and the piston outer (5b), each set of raising means (R₁, R₂) comprising a movable raising member (14₁, 14₂), the movable raising members (14₁, 14₂) being individually capable of pivoting between a non-raised position (A) and a raised position (B) around the axis of the piston inner and outer (5a, 5b), the piston outer (5b) being held at the low compression ratio position (L) when two of the movable raising members (14₁, 14₂) are pivoted to the non-raised position (A), the piston outer (5b) being held at the medium compression ratio position (M) when only one of the movable raising members (14₁, 14₂) is pivoted to the raised position (B), and the piston outer (5b) being held at the high compression ratio position (H) when two of the movable raising members (14₁, 14₂) are pivoted to the raised position (B).
